(19) United States
(12) Patent Application Publication
(10) Pub. No.: US 2006/0227813 A1
(43) Pub. Date: Oct. 12, 2006

(54) Method and system for synchronized video recording/delivery

(76) Inventor: Richard A. Mavrogeanes, Wallingford, CT (US)

Correspondence Address: ALIX YALE & RISTAS LLP, 750 MAIN STREET, SUITE 1400, HARTFORD, CT, 06103, US

(21) Appl. No.: 11/401,793

(22) Filed: Apr. 11, 2006

Related U.S. Application Data
(60) Provisional application No. 60/670,184, filed on Apr. 11, 2005.

(51) Int. Cl. H04J 3/06; H04J 3/04

(52) U.S. Cl. 370/509; 370/535

(57) ABSTRACT

A method for synchronizing multiple video recordings comprises inserting a series of time stamps into a live video signal and forming a video data file. A series of time stamps is inserted into a second live video signal and a second video data file is formed. The video files are synchronized by means of the time stamps and the video files are multiplexed into a synchronized multi-program transport stream.

### CROSS-REFERENCE TO RELATED APPLICATION

This application claims the priority of U.S. Provisional Patent Application No. 60/670,184 filed on Apr. 11, 2005.

### BACKGROUND OF THE INVENTION

This invention relates generally to systems and methods for synchronizing video signals.

There are a number of circumstances wherein it is highly desired to synchronize video signals on a real time basis even though the signal may be derived from locations remote from each other.

For example, the U.S. government conducts various military training exercises at diverse locations around the world. Among many goals, warfare training seeks to ensure a tight coordination between multiple entities. These entities may range from multiple armored ground units on a local battlefield, individual soldiers, or multi-force theater operations embracing ground, sea and air forces around the globe.

During an exercise, many video cameras capture the actions. At any given instant, ground forces may take some action while air forces take another action, and while sea forces take yet another action. Each of the forces may be at geographically separated locations at various times throughout the exercise. Each action is captured on video.

After an exercise, it is desirable that participants review the events by watching selected video segments. To re-create the battlefield training events in the most meaningful way, it is necessary to display multiple videos that are synchronized with each other, and with other telemetry (data) signals. In a review, the exercise participants must be able to witness their actions and the simultaneous actions of others.

### SUMMARY OF THE INVENTION

Briefly stated, the invention in a preferred form is a method for synchronizing multiple video recordings comprising receiving a first live video signal, inserting a series of time stamps into the first video signal, forming a first video data file from the first video signal and time stamps, receiving a second live video signal, inserting a series of time stamps into the second video signal, forming a second data file from the second video signal and time stamps, transmitting the first and second video files to a computer synchronizing the first and second video files by means of the time stamps and multiplexing the first and second video files into synchronized multi-program transport stream.

A common national time standard for each of the time stamps may be employed. A recorder may be employed to form the first video data file, and a second recorder remote from the first recorder may be employed for forming the second video data file. Operation of one of the recorders is initiated at a pre-established real time, which may be in accordance with the pre-established schedule. A command is generated to initiate the recorder. The first and second video files may be transmitted to the computer via a standard FTP. The multi-program transport stream may be transmitted to a video on-demand server.

The method may also comprise receiving multiple additional live video signals, inserting a series of time stamps into the multiple video signals, forming additional multiple video data files from the additional multiple signals and additional multiple time stamps and transmitting the additional multiple video files to a computer. The additional video files are synchronized by means of time stamps, and the first and second video files additional multiple video files are multiplexed into a synchronized multi-program transport stream. In one form of the invention, there are multiple video streams. The multi-program transport stream is transmitted at a streaming rate less than approximately 20 MBPS. A specific video channel is decoded from the transport stream. In one preferred embodiment, time stamps are inserted approximately every two seconds.

### BRIEF DESCRIPTION OF THE DRAWINGS

FIG. 1 is a schematic diagram of a system for synchronizing video recording and for illustrating a method for synchronizing multiple video recordings in accordance with the present invention;

FIG. 2 is a schematic diagram illustrating the insertion of time stamps into the video signal; and

FIG. 3 is a schematic drawing illustrating the multiplexing and synchronization of the video streams in accordance with the present invention.

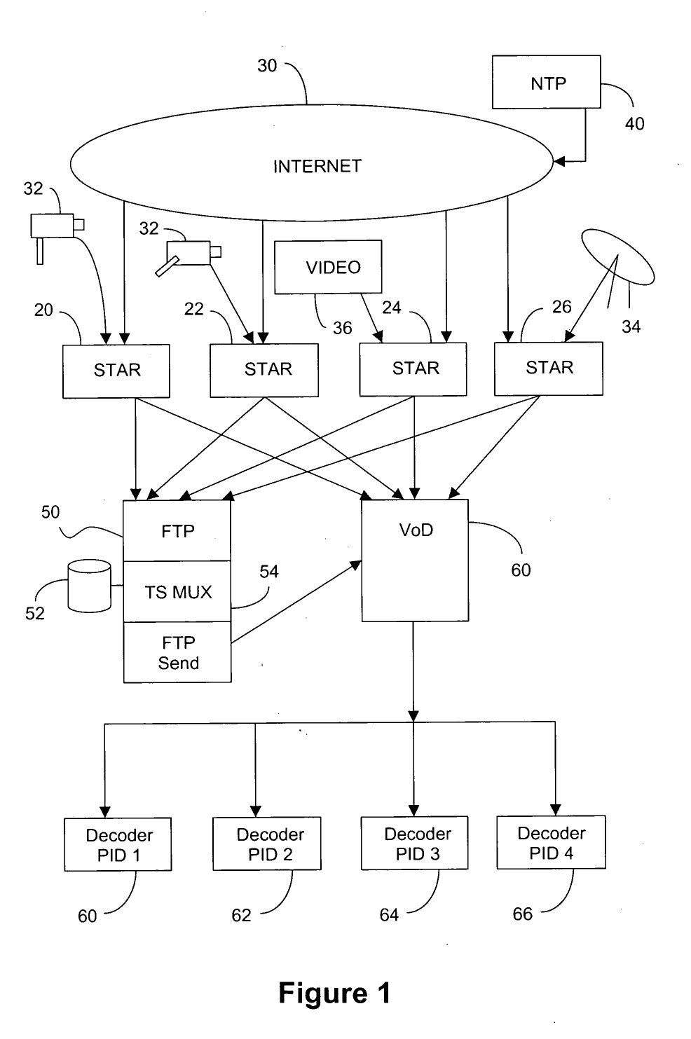

### DETAILED DESCRIPTION OF THE INVENTION

With reference to the drawings wherein like numerals represent like parts throughout the figures, a system which is employed for synchronizing video recordings and transmitting them for viewing disparate video sources and synchronization is generally designated by the numeral 10. Multiple standalone recorders which record MPEG-2 video are designated by the numerals 20, 22, 24 and 26 for illustrative purposes. The recorders may be geographically located throughout the country, or even the world. For example, recorder 10 may be located in an office on the east coast. Video recorder 22 may be located in an office in the southwest. Video recorder 24 may be located in California and video recorder 26 may be located on board a ship. Naturally, various other locations are possible. Each of the standalone recorder appliances is connected to a common IP network, namely, the internet 30. Each of the appliances is connected to maintain a common internal system clock accuracy via the standard NTP network time protocol 40. This time accurate code is inserted in the compressed video within MPEG Group-Of-Pictures headers by each encoder 20, 22, 24, 26.

Each of the multiple video recorder appliances record MPEG-2 video. The video input may be provided by cameras 32, telemetry signals 34 or other video sources 36. Each of the recorder appliances record during various time frames, which span a common real time. The recordings at each appliance may be locally initiated at a given pre-established time. They may be automatically initiated by a schedule, or they may be initiated by a start recording command from various applications, such as software developers kit (SDK) and simple network management protocol (SNMP).

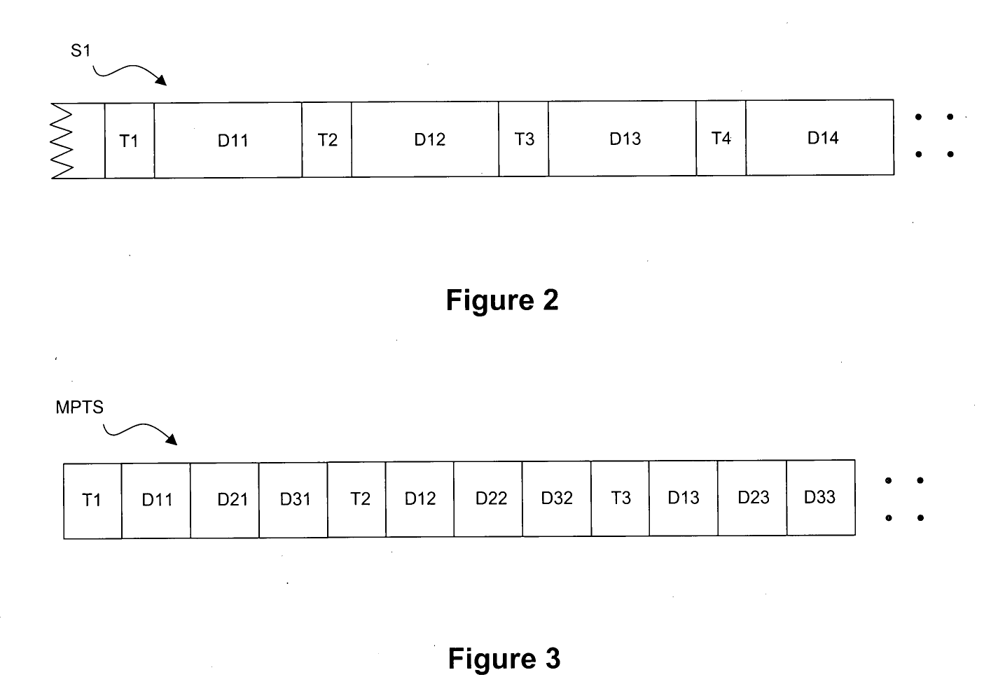

Each of the recorder appliances has integral metadata data capability which includes up to 100 printable ASCII characters. The characters are inserted into the live video upon command of the appliance. With reference to FIG. 2, a series of time stamps T1, T2, T3, T4 . . . indicative of the real time provided by the NTP is inserted into the data streams from the video signal comprising data D11, D12, D13 . . . at each of the recorders. In one form of the invention, insertion of metadata is made every two seconds. The metadata can be used to insert local low speed telemetry or other signals, thereby resulting in inherent synchronization with the video signals.

The extraction of the metadata occurs live with a desktop playback or from a stored file. If extracted from a stored file, the metadata includes a time offset from the start of the file.

After each recording appliance has inserted the time stamps and completed the recordings, the recording video is sent by a standard FTP (File Transport Protocol) to a server 50 in a central location. It should be appreciated that the live MPEG-2 video may have been recorded on desktop appliances, on a video-on-demand server via a scheduled computer controlled recorder or other means. The multiple MPEG-2 files provided by each of the recorder appliances are received by the computer 50 and may be stored in memory 52. The computer 50 includes multiplexer software 54. The files are synchronized by means of the time stamps. The time stamps may be used to interpolate real time recording events for purposes of synchronization. The multiple files are multiplexed into a multi-program transport stream (MPTS) via the software as schematically illustrated in FIG. 3. The resulting file is then placed on a video-on-demand server 60. The resulting MPTS file contains synchronized video from many streams. It should be noted that the capacity depends on the rate of transmission of each stream. Any number of MPTS files can be created. The invention also has applicability with video coding standards other than MPEG-2.

Via desktop controller or otherwise, the video-on-demand server may be instructed to stream the MPTS via the IP multi-cast on the Ethernet/IP network. The streaming rate is approximately equal to the sum of the video rates contained within the MPTS. Typically, the streaming rate is limited to approximately 20 MB per second.

Multiple decoders are configured to receive the IP stream to decode the specific video channel PID such as decoders 60, 62, 64 and 66. To the extent that the live video from the remote recording appliances can be received directly by the video-on-demand system, each individual video may be recorded directly. Each of the remote video recorded and forwarded by the appliances can be placed on the video-on-demand server for individual viewing at various desktops as opposed to a set of multiple appliance recordings.

It can be appreciated, therefore, that the synchronization system and method provides a means wherein various disparate events which are concurrent may be recorded and synchronized so that each of the concurrent events may be viewed in synchronization simultaneously.

What is claimed:

1. A method for synchronizing multiple video recordings comprising:
receiving a first live video signal;
inserting a series of time stamps into said first video signal;
forming a first video data file from said first video signal and time stamps;
receiving a second live video signal;
inserting a series of time stamps into said second video signal;
forming a second video data file from said second video signal and time stamps;
transmitting said first and second video files to a computer;
synchronizing said first and second video files by means of said time stamps; and
multiplexing said first and second video files into a synchronized multi-program transport stream.

2. The method of claim 1, further comprising employing a common national time standard for each of said time stamps;

3. The method of claim 1, further comprising employing a recorder for forming said first video data file and employing a second recorder remote from said first recorder for forming said second video data file.

4. The method of claim 3, further comprising initiating operation of a recorder at a pre-established real time.

5. The method of claim 3, further comprising automatically initiating a recorder in accordance with a pre-established schedule.

6. The method of claim 3, further comprising generating a command to initiate a recorder.

7. The method of claim 1, further comprising transmitting said first and second video files to said computer via standard FTP.

8. The method of claim 1, further comprising transmitting said multi-program transport stream to a video on-demand server.

9. The method of claim 1, further comprising:
receiving multiple additional live video signals;
inserting a series of time stamps into each of said additional multiple video signals;
forming additional multiple video data files from said additional multiple signals and additional multiple time stamps;
transmitting said additional multiple video files to a computer;
synchronizing said additional video files by means of said time stamps; and
multiplexing said first second video files and said additional multiple video files into a synchronized multi-program transport stream.

10. The method of claim 9, wherein there are multiple video streams.

11. The method of claim 1, further comprising transmitting said multi-program transport stream at a streaming rate less than approximately 20 MBPS.

12. The method of claim 1, further comprising decoding a specific video channel from the transport stream.

13. The method of claim 1, further comprising inserting said time stamps approximately every two seconds.
